(19) United States
(12) Patent Application Publication
(10) Pub. No.: US 2015/0338553 A1
(43) Pub. Date: Nov. 26, 2015

(54) METHOD FOR PRODUCING A COAT SYSTEM, COAT SYSTEM AND USE THEREOF

(71) Applicant: Sueddekor GmbH, Laichingen (DE)

(72) Inventor: Heinz Haller, Plochingen (DE)

(21) Appl. No.: 14/363,318

(22) PCT Filed: Sep. 20, 2012
(86) PCT No.: PCT/EP2012/068521

§ 371 Date: Jun. 6, 2014

(30) Foreign Application Priority Data
Dec. 8, 2011 (DE) 10 2011 056 186.2

(51) Int. Cl. G02B 1/12; B01J 35/00; C09D 175/04

(52) U.S. Cl. CPC G02B 1/12; C09D 175/04; B01J 35/004

(57) ABSTRACT

A method for producing a layer arrangement in plate, sheet, or web form, having a photocatalytically active functional layer (4), comprising the steps of: providing a decorative or transparent substrate for coating; applying a solvent-free topcoat material comprising a radiation-curable binder, to produce a topcoat layer (3); applying a functional coating material which comprises a photocatalytically active substance and also an aqueous, dryable and also radiation-curable binder, to produce the photocatalytically active functional layer (4); jointly irradiating the topcoat material and the functional coating material, and hence further-crosslinking, the respective radiation-curable binders, wherein the radiation-curable binder of the topcoat material is preliminarily crosslinked by irradiation, but not cured, and in that the functional coating material is physically dried before the joint irradiation of the topcoat material and of the functional coating material, and wherein the dried functional coating material, is subjected prior to curing, to a surface treatment in the form of a corona treatment and/or a plasma treatment, in which binder of the dried functional coating material is removed.

### BACKGROUND OF THE INVENTION

The invention relates to a method for producing a layer arrangement in plate, sheet, or web form, having a photocatalytically active functional layer, and also to a layer arrangement, produced in particular with such a method.

Photocatalytic coatings are usually used in order to minimize organic contaminants in the ambient air or to eliminate them entirely. Such functional coatings are used advantageously where large areas are exposed to the UV radiation of the sun or artificial light sources. Good effects can be achieved in particular through the coating of window glass or laminate floor systems. Also prior art is the application of photocatalytically active substances in wallpaper inks or on carpet fibers. The photocatalytically active substance used in this context, in other words as catalyst, is a specific TiO₂ pigment, which has been surface-treated and is dispersed more or less finely according to application.

WO 2010/110726 A1 describes the production of catalytic functional coatings. WO 2011/093785 A1 addresses the application associated with the production of melamine coatings for laminate floors.

Described marginally in DE 20 2006 007 317 U1 is the use of catalytically active substances in decorative floor-covering coating films, where the catalytically active substance is part of a topcoat which is provided on a basecoat that features abrasive particles and that is applied in turn on a substrate composed of paper and/or plastic. Described alternatively in DE 20 2006 007 317 U1 is the provision of the catalytic substance in an intermediate layer between the aforementioned topcoat and the basecoat—in this case, the catalytic functional layer does not form an outermost layer of the known layer arrangement.

Known layer arrangements frequently have the problem that the photocatalytically active substance is incompletely dispersed and that large agglomerates of the nanoscale substance lead to light scattering, causing the surface to appear milky and hazy. The catalytic substance may also attack the binder in which it is embedded, and this may lead to graying. Both phenomena are especially disadvantageous when the overall layer arrangement is to be transparent, in order, for example, to be utilized for the coating of window glass sheets. The chemical interaction between the photocatalytic substance and the binder surrounding it is also disadvantageous if a decorative substrate is to be visible without haze through the layers located above it, in order for the layer arrangement to be able to be used as a coating sheet for furniture or the like, for example.

### SUMMARY OF THE INVENTION

On the basis of the above-stated prior art, the object on which the invention is based is that of specifying a method for producing a layer arrangement in plate, sheet, or web form, having a photocatalytically active functional layer, with which arrangement firstly a high level of adhesion exists between the functional layer and a topcoat situated below it, to allow the layer arrangement to withstand even exacting mechanical requirements. Accordingly, for example, the functional layer is not to be removable by wiping and standard household cleaning products. As far as possible, moreover, graying of the functional layer as a result of interaction of the photocatalytically active substance with a binder of the functional layer is to be avoided. Moreover, a high catalytic activity is to be ensured.

A further object is that of specifying a layer arrangement improved accordingly.

This object is achieved for the method for the layer arrangement, and also by the use as disclosed herein.

Advantageous developments of the invention are also specified herein. The ambit of the invention encompasses all combinations of at least two features disclosed in the description, in the claims and/or in the figures. In order to avoid repetition, features disclosed in relation to apparatus are to be considered as disclosed in relation to methods, and are to be claimable. Similarly, features disclosed in relation to methods are to be considered disclosed in relation to apparatus, and are to be claimable.

The invention is based on the concept of applying, either directly to a decorative or transparent substrate for coating, or alternatively to at least one basecoat generated beforehand on the substrate, a solvent-free topcoat material, which subsequently forms a topcoat, which preferably meets demands for good chemical and mechanical robustness and also, optionally, requirements in terms of gloss and possibly color. As radiation-curable binder, the topcoat material may comprise, for example, polyester acrylates, urethane acrylates, and epoxy acrylates, or mixtures of these substances, more particularly with a fraction from a weight % range between 10% and 90%, based on the wet application weight of the topcoat material. In order to achieve particularly good mechanical and chemical properties, it is also possible if required for a nanocomposite coating material to be used as topcoat material. Likewise, if required, pigments used may be organic pigments and/or inorganic pigments such as titanium dioxide and/or iron oxide pigments. In accordance with the invention, the applied topcoat material is partly cured (partly crosslinked) in one method step. This is accomplished by irradiating the topcoat material and at the same time preliminarily crosslinking, i.e., incompletely crosslinking, the radiation-curable binder of the topcoat material. By this is meant that the radiation-curable binder is subjected to preliminary crosslinking, using UV light and/or electron radiation, in such a way that there are still a sufficient number of double bonds present for a subsequent radical polymerization. The crosslinking takes place preferably to a degree of polymerization of between 20% and 50%. In the case of UV irradiation, the curing of the coating material may be controlled by the fraction of the photoinitiator needed and/or by the radiation dose. In the case of electron irradiation, the degree of preliminary crosslinking is controlled by the radiation dose, since no photoinitiators are needed for the curing of the topcoat material and are preferably also not present. The topcoat material may be transparent or pigmented. The topcoat material may be applied, for example, by spraying, pouring, or printing, more particularly by means of a roll coating apparatus. The topcoat material is applied preferably in a thickness of between 5 μm and 30 μm, preferably between 8 μm and 15 μm.

In a further method step of the invention, a functional coating material is applied to the preliminarily crosslinked, uncured topcoat material, to produce the photocatalytic functional layer, by means, for example, of pouring, spraying, or printing, more particularly by means of a gravure device, this functional coating material comprising not only at least one photocatalytically active substance but also an aqueous, physically dryable and radiation-curable binder. Examples of binders which can be used in the functional coating material include aqueous urethane dispersions. With very particular preference, the functional coating material is applied in a layer thickness of between 0.5 μm and 3 μm, preferably between 0.7 μm and 1.2 μm.

In a further method step, then, in accordance with the invention, the functional coating material is dried physically, more particularly thermally, preferably to an extent where the functional coating material is tack-free.

In a further method step according to the invention, the topcoat material and the functional coating material present thereon are jointly irradiated, with UV rays and/or electron radiation, thereby further-crosslinking, more particularly curing, the radiation-curable binders present in the aforementioned coating materials. Following the joint irradiation, the photocatalytic substance is present in physically incorporated (not chemically bonded) form in the binder of the functional layer, with the substance preferably already partly appearing at and/or forming the outer surface.

The method of the invention results in a layer arrangement which can be employed for a very wide variety of applications and which is distinguished by a multiplicity of advantageous properties. For instance, the layer arrangement resulting from the method is extremely robust, this being attributable to the effective adhesion or bonding between functional layer and topcoat layer. This is attributable in turn to the fact that functional layer and topcoat layer are cured in a joint irradiation step, producing a crosslinking between the radiation-curable binders of the functional coating material and the radiation-curable binders of the topcoat material. Furthermore, the incorporation of the photocatalytically active substance into a radiation-cured binder, preferably an exclusively radiation-cured binder, produces an extremely strong structure in which the binder is polymerized, by virtue of the radiation curing, to form a particularly strong polymer, which by virtue of the effective crosslinking is largely insensitive toward the catalytic activity of the catalytically active substance. Graying of the bordering topcoat layer or of a boundary region of this layer is minimized for the same reason—here, by virtue of the radiation curing, preferably exclusive radiation curing, a particularly strong and resistant polymer structure has been produced.

Functional coating material and/or topcoat material are/is preferably free from binders which are not radiation-curable.

The particle size of the photocatalytically active substance, more particularly of TiO₂, is advantageously selected such that it is smaller than the wavelength of visible light, in order to avoid light scattering and hence a whitening effect. The maximum particle size of the substance, more particularly TiO₂, is preferably less than 300 nm, more preferably less than 200 nm. It is also advantageous for the average particle size of the substance to be less than 100 nm, preferably less than 75 nm. It has emerged as being particularly advantageous if the substance is carbon-coated, the effect of this being that the substance is catalytically active even in shortwave daylight, not only in the UV range. With very particular preference the substance may be designed as described in WO 2005/108505 A1, whose disclosure content in this context is considered to be disclosed as belonging to the present application.

In order to optimize the catalytic activity of the functional layer, a development of the invention advantageously provides a method step, after the drying of the functional coating material and before the ultimate curing of the functional coating material and of the topcoat material, of subjecting the dried functional coating material to a surface treatment by means of which (additionally) photocatalytically active substance is exposed or brought to the surface. For this purpose, as part of the surface treatment, binder (in part already polymerized) of the dried functional coating material is removed, in order thereby to expose photocatalytically active pigments.

As a surface treatment step it has proved particularly advantageous to provide a corona treatment, in which case the corona treatment is preferably adjusted in such a way that there is no detriment to the further crosslinkability of the preliminarily crosslinked topcoat material located beneath the dried functional coating material. This can be achieved, for example, by a corona power of approximately 4 kW/m. Additionally or alternatively to a corona treatment, other suitable surface steps may be used to expose catalytically active substances enveloped in the binder, an example being a plasma treatment.

As mentioned at the outset, there are in principle various possibilities for the preliminary crosslinking of the topcoat material by irradiation. Thus it is possible, where photoinitiators are provided in the topcoat material, to carry out the preliminary crosslinking by means of UV irradiation, in which case the degree of crosslinking may be controlled through the amount of photoinitiators and/or the radiation dose. Additionally or preferably alternatively, the preliminary crosslinking may take place by means of electron irradiation, in which case the preliminary crosslinking may take place via the choice of the radiation dose. In the case of the preliminary crosslinking irradiation, with particular preference, a degree of polymerization of between 10% and 50%, preferably between 20% and 30%, of the radiation-curable binder of the topcoat material is achieved.

Similarly, the joint curing of functional coating material and topcoat material, where photoinitiators are provided in both coating materials, may take place by means of UV irradiation and also, additionally or preferably alternatively, by means of electron irradiation. In the case of electron irradiation, a dose power of 30 kGy of the electron irradiation has emerged as being advantageous. Curing is accomplished preferably such as to achieve a degree of polymerization of greater than 80%, preferably greater than 90%, very preferably of approximately 100% of the binder of the topcoat layer and/or of the functional layer.

It is especially judicious for the method step of the physical drying, more particularly thermal drying, of the functional coating material to be performed temporally before a joint irradiation of functional coating material and topcoat material, in such a way that the functional coating material is tack-free after the thermal drying. With particular preference, the functional coating material is dried to an extent such that it has a residual moisture content of less than 5 wt %, preferably less than 4 wt %, more preferably less than 3 wt %, very preferably less than 2 wt %, very preferably less than 1 wt %, based on the weight of the applied functional coating material. The drying process improves the outcome of the optional yet preferred surface treatment, more particularly corona treatment. In particular, a flashlike evaporation of water during the treatment, and hence a forced entrainment of further substances, is prevented, with consequences for the surface quality as well.

For coating purposes, the substrate may be present in a variety of forms. Particularly advantageous is an embodiment of the method in which the substrate is present in the form of a substrate web, more particularly in the form of paper web, plastics web, metal web, or composite material web, preferably comprising at least one of the aforementioned materials. Alternatively it is possible for the substrate to be present ultimately in plate form, as for example in the form of paper plate, woodbase material plate, plastics plate, metal plate, or composite material plate, comprising at least one of the aforementioned materials. Instead of comparatively thick plates with a thickness of preferably greater than 500 μm, or greater than 1 mm, the substrate may also be in sheet form, in which case the thickness extent is preferably much less than 500 μm, more particularly less than 200 μm.

It is particularly judicious for the method to be carried out inline, at least in that the steps of application of the topcoat material, and also, optionally—where provided—the application of at least one optional basecoat material beneath the topcoat material, the application of the functional coating material, the drying, and the curing, are carried out inline, a particularly suitable form of substrate for an inline procedure being a web form, since this substrate can then be processed from roll to roll (from coil to coil).

In order to achieve good optimal photocatalytic activity, it is judicious for the functional coating material to comprise an amount of catalytic substance and to be applied in a thickness such as to result in an amount of the photocatalytic substance per unit area of between about 0.2 g/m² and 3 g/m², preferably of about 1 g/m² in the layer arrangement.

With regard to the choice of the photocatalytic active substance, it has emerged as being advantageous to use specific, coated titanium dioxide grades, which are preferably in nanoscale form. Very preferably the average particle size is between 70 nm and 20 nm. Very preferably the titanium dioxide is in the form of primary particles. Primary particles are individual particles which are not agglomerated and which can no longer be broken down smaller by stirring or vigorous dispersing.

As explained at the outset, it is possible in principle—for applications, for example, in which the layer arrangement is to be used as a coating foil for the coating of furniture or the like—for the topcoat material to be applied directly onto the substrate. Alternatively, at least one layer of a basecoat material may be provided between topcoat material and substrate. In this case, therefore, the topcoat material is applied preferably to the previously applied basecoat material, which with further preference comprises radiation-curable binder and is preliminarily crosslinked, i.e., not cured, specifically by irradiation, before the topcoat material is applied, more particularly for the purpose of joint curing of the basecoat material together with the topcoat material and the functional coating material at the end of the method. Also conceivable is the full curing of the basecoat material before the topcoat material is applied. As and when required, the basecoat material may have abrasive fillers, more particularly in a layer which borders the topcoat layer, which preferably comprises abrasive particles. As and when required it is possible, in addition to a base layer having abrasive fillers, e.g., corundum, to provide a further base layer without abrasive fillers.

The invention also leads to a layer arrangement, preferably but not necessarily produced by a method established in accordance with the concept of the invention, and comprising an (outer) photocatalytically active functional layer, a topcoat layer bordering it, and a decorative or transparent substrate, where the top layer and the functional layer each comprise radiation-cured (polymerized) binder and where the radiation-cured binders of functional layer and topcoat layer are mutually crosslinked with one another.

The surface (functional layer) of the layer arrangement of the invention has an outstanding photocatalytic efficiency, especially if it has been subjected during production to a surface treatment, more particularly to a corona treatment for the (partial) ablation of radiation-curing, preferably in part already cured binder from the functional layer, more particularly before a drying operation.

The layer arrangement comprises a substrate, which especially for applications on window glass may be transparent, more particularly in the form of a transparent film, as for example a polyester film. In particular, but not exclusively, for the use of the layer arrangement as coating film for the coating of surfaces, it is advantageous to use a decorative substrate, which may be of single-color or multicolor design; more particularly, the decoration may take the form of a decorative pattern, preferably a printed decorative pattern.

The layer arrangement of the invention is, in particular, transparent, preferably such that in the case where the substrate is designed as a decorative substrate, it can be viewed optimally through the layers located above it. For use on glass windows, additionally, the substrate must be transparent, in order for it to be possible to see through the layer arrangement overall. The layer arrangement may constitute a transparent protection against water and standard household chemicals, and continues to have good chemical resistance properties in spite of a high transparency at least on the part of the coating material layer and the top layer.

For the use of the layer arrangement as furniture foils, i.e., for the laminating of furniture, it is advantageous for the substrate to be a pretreated printed paper. Coating foils of these kinds may be laminated, for example, to medium- or high-density fiberboard or chipboard panels. It is also possible to laminate wall panels and ceiling panels. In all applications it is advantageous if these are used within a residence and provide relatively large areas which are exposed to light and are in contact with ambient air.

### BRIEF DESCRIPTION OF THE DRAWINGS

Further advantages, features, and details of the invention will become apparent from the description hereinbelow of preferred working examples, and also from the drawings; in the single FIGURE,

FIG. 1, these drawings show a schematic layer construction diagram as a side sectional view through a working example of a decorative or fully transparent layer arrangement 1 of the invention.

### DETAILED DESCRIPTION

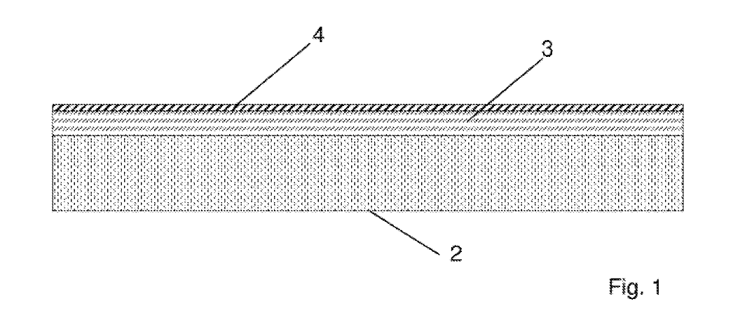

FIG. 1 shows one possible embodiment of a layer arrangement 1, which can be employed for various applications, in particular in accordance with the design of a substrate 2. It is possible for the substrate 2 to be designed as a decorative substrate 2 or as a transparent substrate 2. It is also possible, alternatively, to select a web-form or sheet-form, in other words very thin, flexible substrate variant, or a comparatively rigid substrate 2 in leaflet form. In the working example shown, the substrate 2 is a substrate in sheet or web form, more particularly a paper or a foil. The thickness extent is about 30 μm to 100 μm.

In the working example shown there is a topcoat layer 3 located directly on the substrate 2, and comprising a cured, radiation-crosslinked binder. Located as outermost layer on this topcoat layer 3 is a photocatalytic active functional layer 4, likewise comprising a beam-cured binder, the radiation-cured binders of the layers 3 and 4 being crosslinked with one another in a transition or interface region.

In an alternative embodiment, not shown, of a layer arrangement 1, a preferably radiation-cured base layer may be provided between the substrate 2 and the topcoat layer 3.

In the working example shown, the functional layer 4 has a thickness extent (thickness of about 1 μm). The topcoat layer has a thickness extent of about 10 μm.

One typical formula for producing a UV-curable topcoat material for producing the topcoat layer 3 is as follows:

oligomer (e.g., Ebecryl 952) 100 parts,

monomer (e.g., HDDA) 10 parts,

adhesion promoter (e.g., Ebecryl 168) 3 parts,

photoinitiator (e.g., Darocure 1173) 3 parts.

The topcoat material is applied preferably with an application weight of 10 g/m². Preliminary crosslinking takes place preferably by UV curing with a dose power of about 80 to 120 W/cm, in particular without inertization by nitrogen.

One typical formula for producing a UV-curable functional coating material is as follows:

aqueous binder (e.g., Ucecoat 7773) 25 parts,

functional dispersion (e.g., Kronoclean 7000 at 30% in water) 25 parts,

diluent (e.g., water) 50 parts.

The application weight (wet) is preferably about 10 g/m². Drying takes place preferably at 140° C. until the residual moisture content is less than 3 wt %.

Surface treatment of the dried, as yet not through-cured (fully cured) functional coating material is carried out preferably at 4 KW/m. The final curing of the functional coating material and of the topcoat material is carried out preferably with electron irradiation, with a dose power of 30 kGy. Instead of the aforementioned UV-curable functional coating material and/or instead of the aforementioned UV-curable topcoat material, it is possible for an electron beam curable functional coating material and/or an electron beam curable topcoat material to be used. These materials may have, for example, the same formula as the aforementioned coating materials, apart from the absence of photoinitiators. In the case of polymerization by electron beams, preference is given to using an inert gas atmosphere, since otherwise the atmospheric oxygen would accumulate at the double bonds of the oligomers and would block connection of the polymers (polymerization). Nitrogen, for example, can be used as inert gas.

1. A method for producing a layer arrangement in plate, sheet, or web form, having a photocatalytically active functional layer (4), comprising the steps of:
providing a decorative or transparent substrate for coating;
applying a solvent-free topcoat material comprising a radiation-curable binder, to produce a topcoat layer (3);
applying a functional coating material which comprises a photocatalytically active substance and also an aqueous, dryable and also radiation-curable binder, to produce the photocatalytically active functional layer (4);
jointly irradiating the topcoat material and the functional coating material, and hence further-crosslinking, the respective radiation-curable binders,
wherein
the radiation-curable binder of the topcoat material is preliminarily crosslinked by irradiation, but not cured, and wherein the functional coating material is physically dried before the joint irradiation of the topcoat material and of the functional coating material, and
wherein the dried functional coating material, is subjected prior to curing, to a surface treatment in the form of a corona treatment and/or a plasma treatment, in which binder of the dried functional coating material is removed.

2. The method as claimed in claim 1, wherein the topcoat material comprises photoinitiators and the preliminary crosslinking takes place by means of UV irradiation and/or wherein the preliminary crosslinking takes place by means of electron irradiation.

3. The method as claimed in claim 1, wherein the topcoat material comprises photoinitiators and the curing takes place by means of UV irradiation and/or wherein the curing takes place by means of electron irradiation.

4. The method as claimed in claim 1, wherein the functional coating material is thermally dried such that it is tack-free.

5. The method as claimed in claim 1, wherein the substrate (2) is provided in the form of paper web, plastics web, metal web, laminate web, or in the form of paper plate, woodbase material plate, plastics plate, metal plate, or laminate plate.

6. The method as claimed in claim 1, wherein the application of the topcoat material, the preliminary crosslinking, the application of the functional coating material, the drying, and the curing are carried out inline.

7. The method as claimed in claim 1, wherein the functional coating material comprises an amount of catalytic substance and is applied in a thickness such as to result in an amount of the substance per unit area of between about 0.2 g/m2 and 3 g/m2.

8. The method as claimed in claim 1, wherein surface-treated titanium dioxide is used as photocatalytically active substance.

9. The method as claimed in claim 1, wherein the topcoat material is applied directly to the substrate (2) or to at least one basecoat material comprising abrasive particles, that is applied beforehand to the substrate (2).

10. The method as claimed in claim 9, wherein the basecoat material comprises a radiation-curable binder and, before the application of the topcoat material, is preliminarily crosslinked, not cured, or alternatively is cured.

11. A layer arrangement (1), produced by a method as claimed in claim 1, comprising a photocatalytically active functional layer (4) as an outermost layer, a topcoat layer (3), and a decorative or transparent substrate (2), wherein the topcoat layer (3) and the functional layer (4) each comprise radiation-cured binder and wherein the binders of functional layer (4) and topcoat layer (3) are crosslinked with one another, and wherein the functional layer (4) is a corona-treated and/or plasma-treated layer, and wherein consequently on the surface photocatalytic pigments of the functional layer are exposed.

12. The use of a layer arrangement (1) as claimed in claim 11 for coating surfaces selected from the group consisting of furniture, worktops, floors, laminates, and windows.

13. The method as claimed in claim 4, wherein the functional coating material is thermally dried to a residual moisture content of less than 5 wt. %

14. The method as claimed in claim 4, wherein the functional coating material is thermally dried to a residual moisture content of less than 4 wt. %

15. The method as claimed in claim 4, wherein the functional coating material is thermally dried to a residual moisture content of less than 3 wt. %

16. The method as claimed in claim 4, wherein the functional coating material is thermally dried to a residual moisture content of less than 2 wt. %

17. The method as claimed in claim 4, wherein the functional coating material is thermally dried to a residual moisture content of less than 1 wt. %

18. The method as claimed in claim 7, wherein the functional coating material is applied in a thickness to result in a thickness to result in an amount of the substance per unit area of 1 g/m².

19. The method as claimed in claim 8, wherein the surface-treated titanium dioxide is nanoscale surface surface-treated titanium dioxide.

20. The method as claimed in claim 19, wherein the nanoscale, surface-treated titanium dioxide is in the form of primary particles.
